(19) United States
(12) Patent Application Publication
(10) Pub. No.: US 2011/0298722 A1
(43) Pub. Date: Dec. 8, 2011

(54) INTERACTIVE INPUT SYSTEM AND METHOD

(75) Inventors: Edward Tse, Calgary (CA); Andy Leung, Calgary (CA); Shymmon Banerjee, Calgary (CA)

(73) Assignee: SMART Technologies ULC, Calgary, AB (CA)

(21) Appl. No.: 12/794,655

(22) Filed: Jun. 4, 2010

(51) Int. Cl. G06F 3/041; G06F 3/033

(52) U.S. Cl. 345/173; 715/863

(57) ABSTRACT

An interactive input system includes an interactive surface, at least one proximity sensor positioned in proximity with the interactive surface; and processing structure communicating with the sensor and processing sensor output from the at least one proximity sensor for detecting a user in proximity with the interactive surface. A method of providing input into an interactive input system having an interactive surface includes communicating sensor output from at least one proximity sensor positioned in proximity with the interactive surface to processing structure of the interactive input system; and processing the sensor output for detecting a user located in proximity with the interactive surface.

### FIELD OF THE INVENTION

The present invention relates generally to interactive input systems methods of using the same.

### BACKGROUND OF THE INVENTION

Interactive input systems that allow users to inject input (e.g., digital ink, mouse events etc.) into an application program using an active pointer (e.g., a pointer that emits light, sound or other signal), a passive pointer (e.g., a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Multi-touch interactive input systems that receive and process input from multiple pointers using machine vision are also known. One such type of multi-touch interactive input system exploits the well-known optical phenomenon of frustrated total internal reflection (FTIR). According to the general principles of FTIR, the total internal reflection (TIR) of light traveling through an optical waveguide is frustrated when an object such as a pointer touches the waveguide surface, due to a change in the index of refraction of the waveguide, causing some light to escape from the touch point. In a multi-touch interactive input system, the machine vision system captures images including the point(s) of escaped light, and processes the images to identify the position of the pointers on the waveguide surface based on the point(s) of escaped light for use as input to application programs.

U.S. patent application Ser. No. 12/259,583 to Morrison, et al. discloses a method an apparatus for determining the position of a projection surface. A camera mounted on the projector is used to determine the location of a user in front of the projection surface. The position of the projection surface is then adjusted according to the height of the user.

United States Publication No. 20070273842 to Morrison, et al. discloses a projection system where a projector is used to project an image for display on a background. The projected light is inhibited from exposing subject's eyes when the subject is positioned in front of the background. Images are captured of the background including the displayed image and the subject. Images are processed to detect the existence and location of a subject whereby the subject's eyes are shaded in the projected light.

While the above-described prior art systems and methods provide various approaches for receiving user's input, limited functionality is available for adapting display content to a user's position relative to an interactive surface. It is therefore an object of an aspect of the following to provide a novel interactive input system and method.

### SUMMARY OF THE INVENTION

Accordingly, in one aspect there is provided an interactive input system comprising:
an interactive surface;
at least one proximity sensor positioned in proximity with the interactive surface; and
processing structure communicating with the sensor and processing sensor output from the at least one proximity sensor for detecting a user in proximity with the interactive surface.

In another aspect there is provided a method of providing input into an interactive input system having an interactive surface, the method comprising:
communicating sensor output from at least one proximity sensor positioned in proximity with the interactive surface to processing structure of the interactive input system; and
processing the sensor output for detecting a user located in proximity with the interactive surface.

### BRIEF DESCRIPTION OF THE DRAWINGS

Embodiments will now be described more fully with reference to the accompanying drawings in which:

FIG. 1 is a perspective view of an interactive input system.

FIG. 2 is a top plan view of the interactive input system of FIG. 1 installed in an operating environment.

FIG. 3A is a graphical plot of an output of a proximity sensor as a function of time for use with the interactive input system of FIG. 1.

FIG. 3B is a graphical plot showing output of a set of proximity sensors at one point in time and as a function of sensor position for use with the interactive input system of FIG. 1.

FIGS. 4A to 4D are graphical plots showing output from each of the proximity sensors in the set of FIG. 3B as a function of time.

FIG. 5 is a schematic diagram showing operating modes of the interactive input system of FIG. 1.

FIG. 6 is a flowchart showing steps in an operation method used by the interactive input system of FIG. 1.

FIG. 7 is a flowchart showing steps in a user interface component updating step of the method of FIG. 6.

FIGS. 8A to 8D are examples of display content configurations for use with the interactive input system of FIG. 1.

FIGS. 9A to 9C are examples of hand gestures recognizable by the interactive input system of FIG. 1.

FIGS. 10A and 10B are more examples of display content configurations for use with the interactive input system of FIG. 1.

FIG. 11 is a view of another embodiment of an interactive input system installed in an operating environment.

FIG. 12 is a view of still another embodiment of an interactive input system installed in an operating environment.

FIGS. 13A to 13C are views of yet another embodiment of an interactive input system.

FIG. 13D shows still yet another embodiment of an interactive input system.

FIG. 14 is a perspective view of another embodiment of an interactive input system.

FIG. 15 is a top plan view of a display content configuration for use with the interactive input system of FIG. 14.

FIG. 16A to 16D are top plan views of further display content configurations for use with the interactive input system of FIG. 14.

FIGS. 17A and 17B are top plan views of still further display content configurations for use with the interactive input system of FIG. 14.

### DETAILED DESCRIPTION OF THE EMBODIMENTS

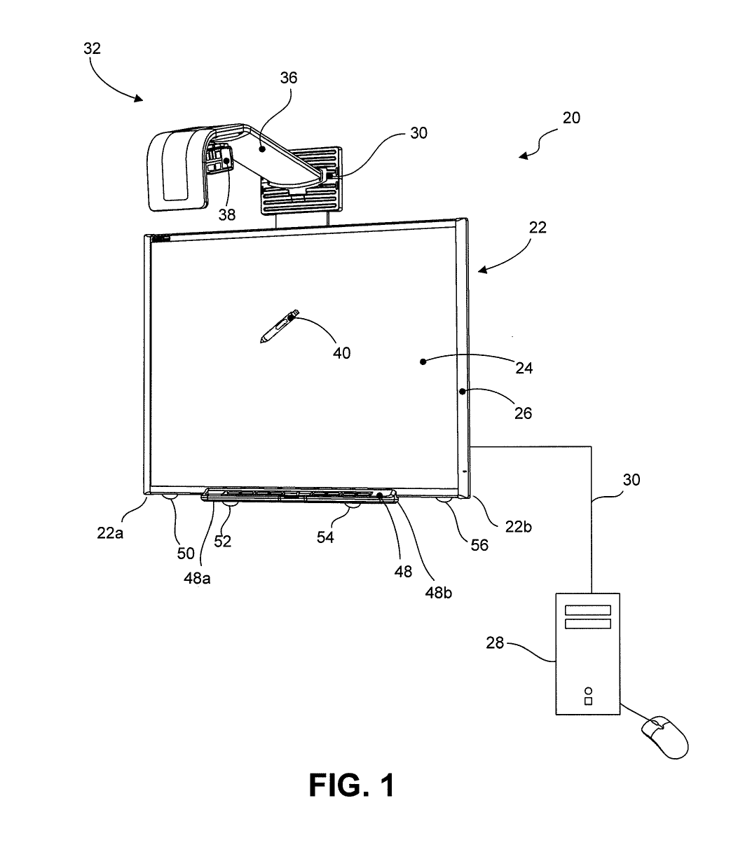

Turning now to FIG. 1, an interactive input system that allows a user to inject input such as digital ink, mouse events etc., into an application program executed by a computing device is shown and is generally identified by reference numeral 20. In this embodiment, interactive input system 20 comprises an interactive board 22 mounted on a vertical support surface such as for example, a wall surface or the like. Interactive board 22 comprises a generally planar, rectangular interactive surface 24 that is surrounded about its periphery by a bezel 26. A boom assembly 32 is also mounted on the support surface above the interactive board 22. Boom assembly 32 provides support for a short throw projector 38 such as that sold by SMART Technologies ULC under the name “SMART Unifi 45”, which projects an image, such as for example a computer desktop, onto the interactive surface 24.

The interactive board 22 employs machine vision to detect one or more pointers brought into a region of interest in proximity with the interactive surface 24. The interactive board 22 communicates with a computing device 28 executing one or more application programs via a universal serial bus (USB) cable 30. Computing device 28 processes the output of the interactive board 22 and adjusts image data that is output to the projector 38, if required, so that the image presented on the interactive surface 24 reflects pointer activity. In this manner, the interactive board 22, computing device 28 and projector 38 allow pointer activity proximate to the interactive surface 24 to be recorded as writing or drawing or used to control execution of one or more application programs executed by the computing device 28.

The bezel 26 in this embodiment is mechanically fastened to the interactive surface 24 and comprises four bezel segments that extend along the edges of the interactive surface 24. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces extend in a plane generally normal to the plane of the interactive surface 24.

A tool tray 48 is affixed to the interactive board 22 adjacent the bottom bezel segment using suitable fasteners such as for example, screws, clips, adhesive etc. As can be seen, the tool tray 48 comprises a housing having an upper surface configured to define a plurality of receptacles or slots. The receptacles are sized to receive one or more pen tools 40 as well as an eraser tool (not shown) that can be used to interact with the interactive surface 24. Control buttons (not shown) are provided on the upper surface of the housing to enable a user to control operation of the interactive input system 20. Further details of the tool tray 48 are provided in U.S. patent application Ser. No. 12/709,424 to Bolt, et al., filed on Feb. 19, 2010, and entitled “INTERACTIVE INPUT SYSTEM AND TOOL TRAY THEREFOR”, the content of which is herein incorporated by reference in its entirety.

Imaging assemblies (not shown) are accommodated by the bezel 26, with each imaging assembly being positioned adjacent a different corner of the bezel. Each of the imaging assemblies has an infrared light source and an imaging sensor having an associated field of view. The imaging assemblies are oriented so that these fields of view overlap and look generally across the entire interactive surface 24. In this manner, any pointer such as for example a user's finger, a cylinder or other suitable object, or a pen or eraser tool lifted from a receptacle of the tool tray 48, that is brought into proximity of the interactive surface 24 appears in the fields of view of the imaging assemblies.

The computing device 28 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The computer may also comprise networking capability using Ethernet, WiFi, and/or other network format, for connection to access shared or remote drives, one or more networked computers, or other networked devices.

The computing device 28 runs a host software application such as SMART Notebook™ offered by SMART Technologies Inc. of Calgary, Alberta, Canada. As is known, during execution, the SMART Notebook™ application provides a graphical user interface comprising a canvas page or palette, that is presented on the interactive surface 24, and on which freeform or handwritten ink objects together with other computer generated objects can be input and manipulated via pointer interaction with the interactive surface 24.

The interactive input system 20 is able to detect passive pointers such as for example, a user's finger, a cylinder or other suitable object as well as passive and active pen tools 40 that are brought into proximity with the display surface 24 and within the fields of view of the imaging assemblies.

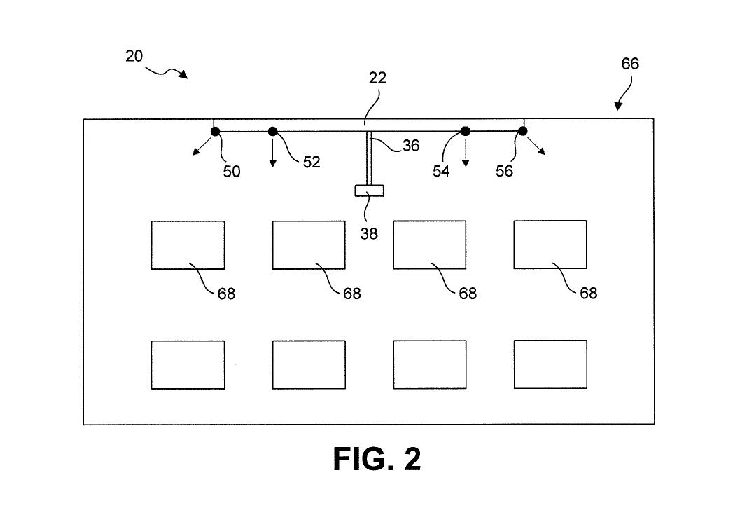

Now, with reference to both FIGS. 1 and 2, interactive input system 20 also comprises one or more proximity sensors configured for sensing the presence of objects, such as a user, in proximity with the interactive board 22. The proximity sensors are in communication with a master controller (not shown) located within tool tray 48, which is in turn in communication with the computing device 28. In this embodiment, the interactive input system 20 comprises a pair of proximity sensors 50 and 56 mounted on an underside of the interactive board 22, and near first and second ends 22a and 22b, respectively, and a pair of proximity sensors 52 and 54 mounted on an underside of the tool tray 48 and on detachable tool tray modules 48a and 48b, respectively. Here, the distance between the sensors 52 and 54 is greater than the width of an average adult person.

Proximity sensors 50, 52, 54 and 56 may be any kind of proximity sensor known in the art. Several types of proximity sensors are commercially available such as, for example, sonar-based, infrared (IR) optical-based, and CMOS or CCD image sensor-based proximity sensors. In this embodiment, each of the proximity sensors 50, 52, 54 and 56 is a Sharp IR Distance Sensor 2Y0A02 manufactured by Sharp Electronics Corp., which is capable of sensing the presence of objects within a detection range of 0.2 m to 1.5 m. As will be appreciated, this range is well suited for use of interactive input system 20 in a classroom environment, for which detection of objects in the classroom beyond this range may be undesirable. However, other proximity sensors may alternatively be used. For example, in other embodiments, each of the proximity sensors may be a MaxBotix EZ-1 sonar sensor manufactured by MaxBotix® Inc., which is capable of detecting the proximity of objects within the range of 0 m to 6.45 m.

As shown in FIG. 2, interactive board 22 may operate in an operating environment 66 in which one or more fixtures 68 are located. In this embodiment, the operating environment 66 is a classroom and fixtures 68 are desks, however, as will be understood, interactive board 22 may alternatively be used in other environments. Once the interactive board 22 has been installed in the operating environment 66, the interactive board 22 is calibrated so as to allow proximity sensors 50, 52, 54 and 56 to sense the presence of fixtures 68 in their respective detection ranges. Proximity sensors 50, 52, 54 and 56 communicate calibration data to the master controller, which receives the calibration data from each of the proximity sensors and saves these outputs in memory as a set of individual baseline values.

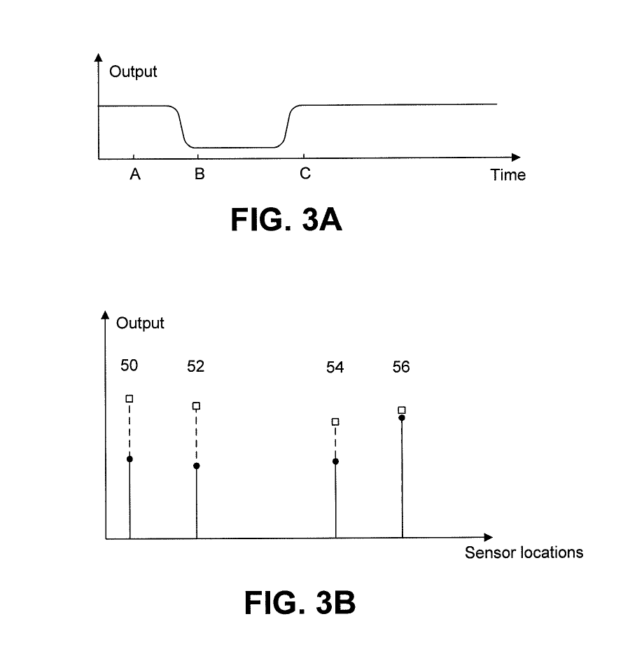

FIG. 3A shows a graphical plot of a typical output of one of the proximity sensors 50, 52, 54 and 56 over a period of time during which an object, such as a user, enters and exits a detection range of the proximity sensor. At times A and C, when the moving object is not within the detection range of the proximity sensor, the sensor outputs the baseline value determined during calibration. At time B, when the object is within the detection range of the sensor, the sensor outputs a value differing from the baseline value and generally corresponding to the distance to the object.

The master controller periodically acquires data from all proximity sensors 50, 52, 54 and 56, and then compares this data to the baseline values determined for each of the sensors to detect the presence of objects in proximity with interactive board 22. Computing device 28 then stores this acquired output in memory for future reference. As will be appreciated, the presence of one or more users, and their respective location relative to the interactive board 22, may be determined from such data. For example, if adjacent proximity sensors output values that are similar or within a predefined threshold of each other, the system can determine that the two sensors are detecting the same object. Here, the size of an average user and the known spatial configuration of proximity sensors 50, 52, 54 and 56 may be considered in determining whether one or more users are present. FIG. 3B shows a graphical plot of data obtained from each of the proximity sensors 50, 52, 54 and 56 at a single point in time, wherein the x-axis represents sensor position along to the interactive board 22. Here, the circle symbols indicate the value output by each of the proximity sensors, while the square symbols indicate the baseline value for each of the proximity sensors. In this Figure, the values output by proximity sensors 50, 52 and 54 are similar. As proximity sensors 50 and 52 are closely spaced, the system will determine that sensors 50 and 52 are both sensing a first user at a location in between the sensors 50 and 52, and having a distance from the interactive board 22 generally corresponding to an average of the outputs of sensors 50 and 52. As proximity sensor 54 is spaced from sensors 50 and 52, the system will also determine that sensor 54 is detecting a second user in front of the interactive board 22. As the output of sensor 56 does not differ significantly from the baseline value for that sensor, the system determines that the second user is located only in front of sensor 54, and not in front of sensor 56. In this manner, the system identifies the number and respective locations of one or more users relative to the interactive board 22, and therefore relative to the interactive surface 24.

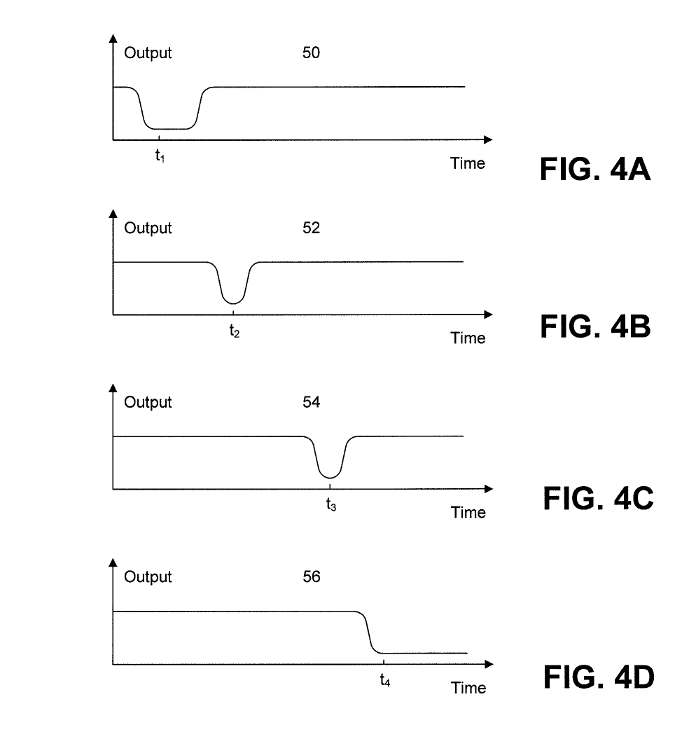

The system can also use the data output by the proximity sensors 50, 52, 54 and 56 to detect and monitor movement of objects relative to interactive board 22. FIGS. 4A to 4D show graphical plots of output from each of the proximity sensors as a function of time. Here, a user is sensed by sensors 50, 52, 54 and 56 in a sequential manner generally at times t₁, t₂, t₃ and t₄, respectively. Based on this data and on the known spatial configuration of proximity sensors 50, 52, 54 and 56, the system is able to determine that the user is moving from the first end 22a to the second end 22b of the interactive board 22. This movement can be utilized by the system as a form of user input, as will be further described below.

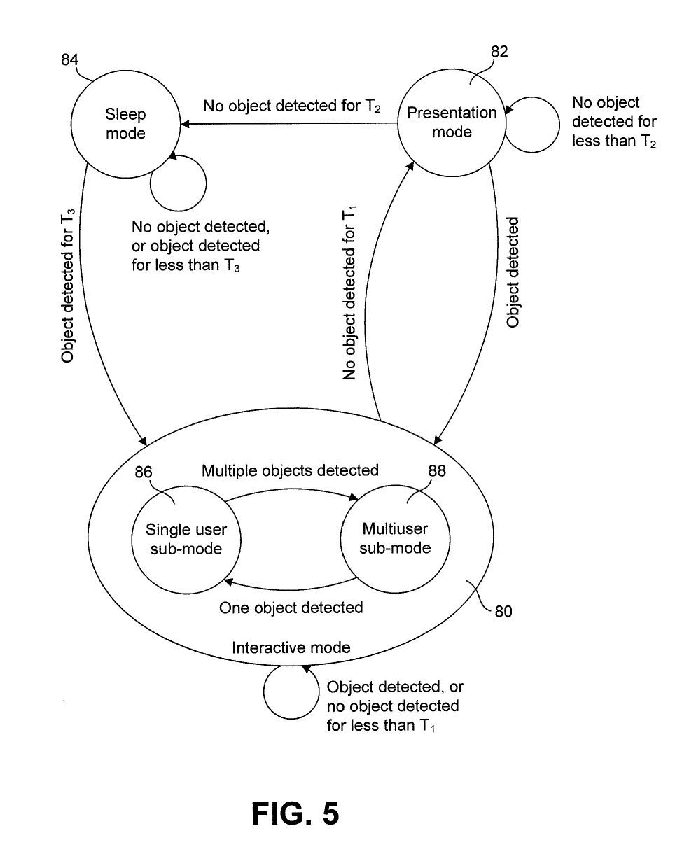

Interactive input system 20 has several different operating modes, as schematically illustrated in FIG. 5. In this embodiment, these modes of operation are interactive mode 80, presentation mode 82, and sleep mode 84. In interactive mode 80, display content with which one or more users may interact is displayed on the interactive board 22. Here, the display content may include any of, for example, a SMART Notebook™ page, a presentation slide, a document, and an image, and also may include one or more user interface (UI) components. The UI components are generally selectable by a user through pointer interaction with the interactive surface 24. The UI components may be any of, for example, a menu bar, toolbars, toolboxes, and page thumbnails.

Interactive mode 80 has two sub-modes, namely a single user sub-mode 86 and a multi-user sub-mode 88, and interactive input system 20 alternates between sub-modes 86 and 88 according to the number of users detected in front of interactive board 22 based on the output of proximity sensors 50, 52, 54 and 56. When only a single user is detected, interactive input system 20 operates in the single user sub-mode 86, in which the display content includes only one set of UI components. When multiple users are detected, interactive input system 20 operates in multi-user sub-mode 88, in which a set of UI components are provided for each detected user and at respective locations on interactive surface 24 near each of the detected locations of the users.

If no object is detected during a period of time T₁ while the interactive input system 20 is in interactive mode 80, the system 20 enters the presentation mode 82. In the presentation mode 82, content is displayed on interactive board 22 in full screen and UI components are hidden. During the transition from interactive mode 80 to presentation mode 82, the system 20 stores in memory the display content that was displayed on interactive surface 24 immediately prior to the transition. This stored content is used for display set-up when the system again enters the interactive mode 80 from either the presentation mode 82 or the sleep mode 84. The stored content may comprise any customizations made by the user, such as, for example, any arrangement of moveable icons placed by the user, and any pen colour selected by the user.

If an object is detected while the system is in presentation mode 82, the system enters the interactive mode 80. Otherwise, if no object is detected during a period of time T₂ while the interactive input system 20 is in presentation mode 82, the system 20 enters the sleep mode 84. In this embodiment, as much of the system 20 as possible is shut off during sleep mode 84 so as to save power, with the exception of circuits required to “wake up” the system 20, which include circuits required for the operation and monitoring of proximity sensors 52 and 54. If an object is detected for a time period that exceeds a threshold time period T₃ while the system is in sleep mode 84, the system enters the interactive mode 80. Otherwise, the system 20 remains in sleep mode 84.

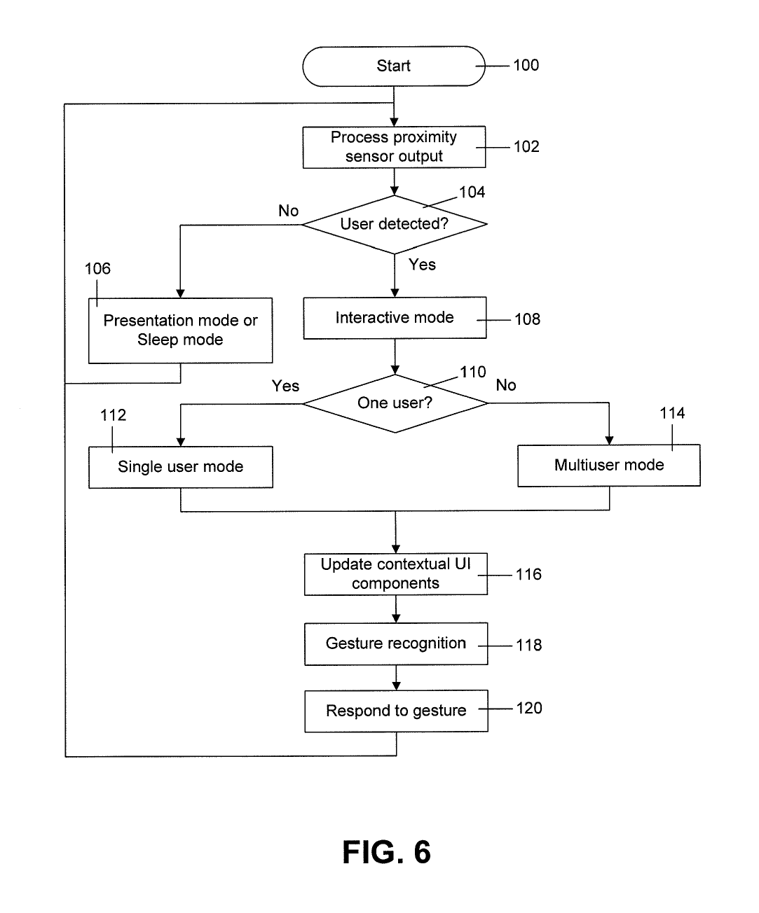

FIG. 6 is a flowchart showing steps in a method of operation of interactive input system 20. It will be understood that, in the following description, display content and/or system settings are updated when the system transitions between modes, as described above with reference to FIG. 5. After the system 20 starts (step 100), it automatically enters the presentation mode 82. The system then monitors the output of proximity sensors 50, 52, 54 and 56 to determine if users are near the interactive board 22 (step 102). During operation, if no user is detected for any period of time T₁, the system 20 enters the presentation mode 82 (step 104), or remains in the presentation mode 82 if it is already in this mode, and returns to step 102. If while in presentation mode 82 no users are detected for a time period that exceeds a threshold time period T₂, the system 20 enters the sleep mode 84, and returns to step 102.

If a user is detected at step 104 for a period of time exceeding T₃, the system 20 counts the total number of detected users (step 110). If only one user is detected, the system enters the single user sub-mode 86 (step 112), or remains in the single user sub-mode 86 if it is already in this sub-mode. Otherwise, the system enters the multi-user sub-mode 88 (step 114). The system 20 then updates the UI components displayed on interactive board 22 (step 116) according to the number of users present.

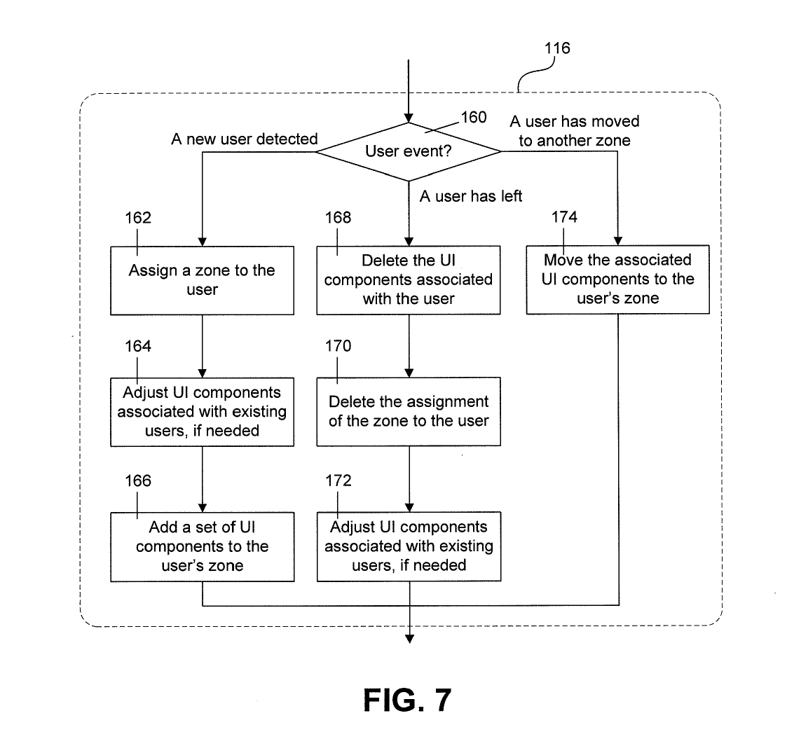

FIG. 7 is a flowchart of steps used for updating UI components in step 116. The system 20 first compares the output obtained by proximity sensors 50, 52, 54 and 56 to previous sensor output stored in memory to identify a user event (step 160). Here, a user event includes any of an appearance of a user, a disappearance of a user, and movement of a user. The interactive surface 24 may be divided into a plurality of zones, on which display content can be displayed for a respective user assigned to that zone when the system 20 is in multi-user mode. In this embodiment, the interactive surface has two zones, namely a first zone which occupies the left half of the interactive surface 24 and a second zone which occupies the right half of the interactive surface 24. If an appearance of a user is detected, the system assigns a nearby available zone of the interactive surface 24 to the new user (step 162). The UI components associated with existing users are then adjusted (step 164), which involves the UI components being resized and/or relocated so as to make available screen space on interactive surface 24 for the new user. A new set of UI components are then added to the zone assigned to the new user (step 166).

If a disappearance of a user is detected at step 160, the UI components previously assigned to this user are deleted (step 168), and the assignment of the zone to that user is also deleted (step 170). The deleted UI components may be stored in the system, so that if an appearance of a user is detected near the deleted zone within a time period T₄, that user is assigned to that deleted zone (step 162) and the stored UI components are displayed (step 166). In this embodiment, the screen space of the deleted zone is assigned to one or more existing users. For example, if one of two detected users disappears, the entire interactive surface 24 is then assigned to the existing user. Following step 170, the UI components associated with remaining user or users are adjusted accordingly (step 172).

If it is determined at step 160 that a user has moved away from a first zone assigned thereto and towards a second zone, the assignment of the first zone is deleted and the second zone is assigned to the user. The UI components associated with the user are moved to the second zone (step 174).

Returning to FIG. 6, following step 116 the system 20 then analyzes the output of proximity sensors 50, 52, 54 and 56 to determine if any of the detected objects are gesturing (step 118), and updates the display content displayed on interactive board 22 in response to the gestures, accordingly (step 120). Gesture recognition is further described below. Following step 120, the system then returns to step 102 and continues to monitor the output of proximity sensors 50, 52, 54 and 56 to detect objects.

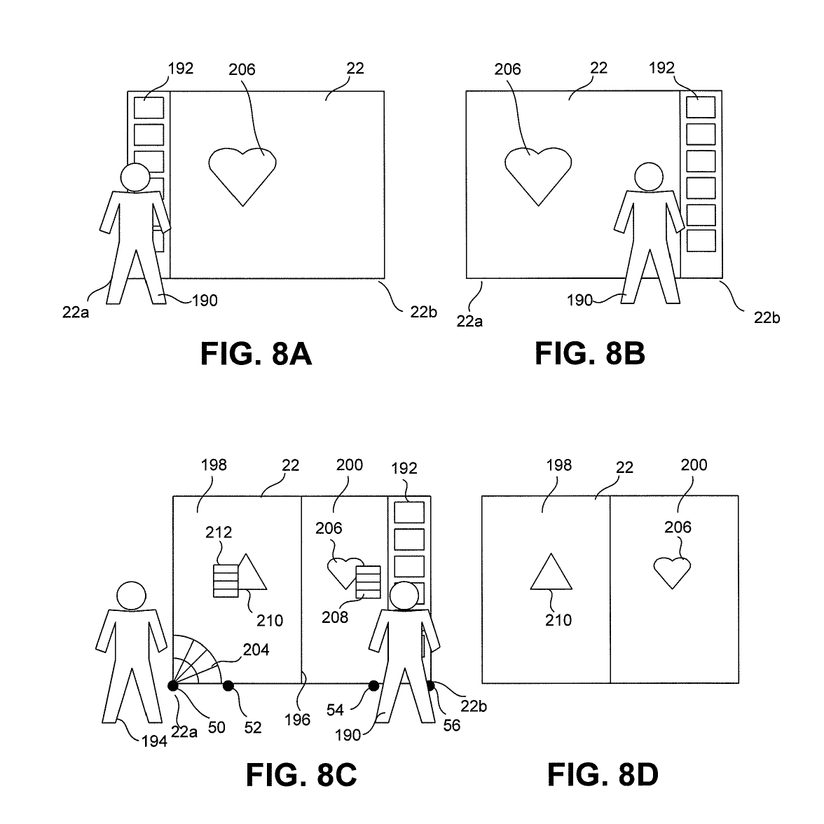

FIGS. 8A to 8D illustrate examples of configurations of display content displayed on the interactive board 22. In FIG. 8A, the system 20 has detected a single user 190 located near first end 22a of interactive board 22. Accordingly, UI components in the form of page thumbnail images 192 are displayed vertically along the left edge of the interactive surface 24. Here, the page thumbnail images 192 are positioned so as to allow the user to easily select one of the thumbnail images 192 by touch input, and without requiring the user 190 to move from the illustrated location. Here, the entire interactive surface 24 is assigned to the user 190. In FIG. 8B, the system has detected that the user 190 has moved towards second end 22b of interactive board 22. Consequently, the page thumbnails 192 are displayed by the system 20 vertically along the right edge of the interactive surface 24.

In FIG. 8C, the system 20 has detected the appearance of a second user 194 located near first end 22a of interactive board 22. As shown, system 20 has entered the multi-user sub-mode 88, and accordingly has divided interactive surface 24 into two zones 198 and 200, and has assigned these zones to users 194 and 190, respectively. A separation line 196 is displayed on the interactive surface 24 to indicate the boundary between zones 198 and 200. The display content for user 190, which includes graphic object 206 and UI components in the form of thumbnail images 192, has been resized proportionally within zone 200. Here, user 190 has been sensed by both proximity sensors 54 and 56, and therefore system 20 has determined that first user 190 is located between these sensors 54 and 56, as illustrated. Accordingly, system 20 displays thumbnail images 192 in full size along a vertical edge of interactive board 22. A new set of UI components in the form of thumbnail images 204 have been added and assigned to user 194, and are displayed in zone 198. Here, user 194 has been detected by proximity sensor 50, but not by proximity sensor 52, and therefore system 20 has determined that first user 194 is located to the left of sensor 50, as illustrated. Accordingly, system 20 displays thumbnail images 204 in a clustered arrangement generally near first end 22a. In the embodiment shown, user 194 has created graphic object 210 in zone 198.

Users may inject input into the system 20 by bringing one or more pointers into proximity with the interactive surface 24. As will be understood by those of skill in the art, such input may be interpreted by the system 20 in several ways, such as for example digital ink or commands. In this embodiment, users 190 and 194 have injected input near graphic objects 206 and 210 so as to instruct system 20 to pop-up respective pop-up menus 208 and 212. Here, pop-up menus 208 and 212 comprise additional UI components, and displayed within boundaries of each respective zone. In this embodiment, the display content that is displayed in each of the zones is done so independently from that of the other zone.

In FIG. 8D, the system 20 has not detected any users near interactive board 22, and has thereby determined that users 194 and 196 have moved away from the interactive board 22. After a time period T₁ has passed, the system 20 has entered the presentation mode 82, wherein presentation pages are displayed within each of the zones 198 and 200. The presentation pages include graphic objects 206 and 210, but do not include UI components in the form of thumbnail images 192 and 204.

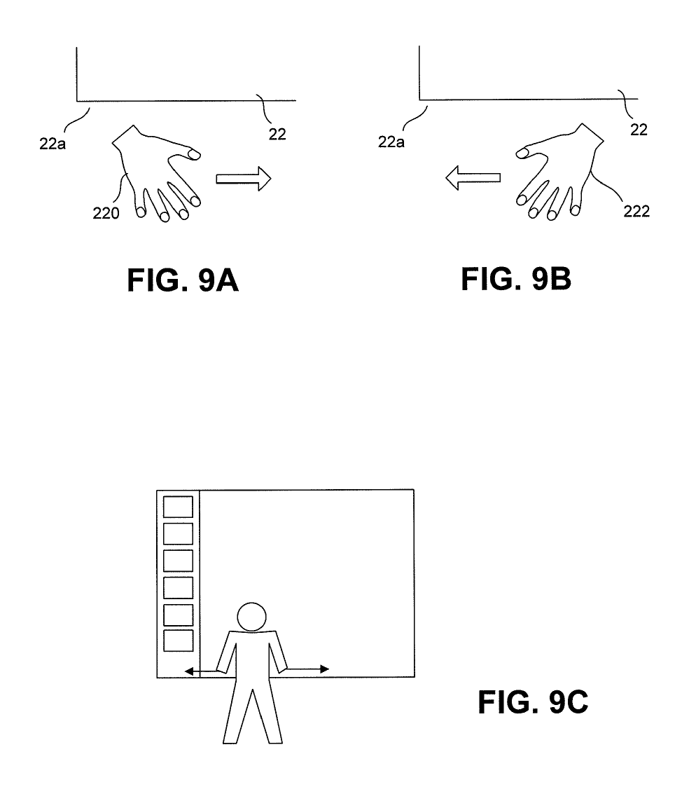

The interactive input system 20 is also able to detect hand gestures made by users within the detection ranges of proximity sensors 50, 52, 54 and 56. FIGS. 9A to 9C show examples of hand gestures that are recognizable by the system 20. FIG. 9A shows a user's hand 220 being waved in a direction generally toward the centre of interactive surface 24. This gesture is detected by the system 20 and, in this embodiment, is assigned the function of forwarding to a next presentation page. Similarly, FIG. 9B shows a user's hand 222 being waved in a direction generally away from the centre of interactive board 22. In this embodiment, this gesture is assigned the function of returning to a previous presentation page. FIG. 9C shows a user moving hands away from each other. This gesture is detectable by the system 20 and, in this embodiment, is assigned the function of zooming into the currently displayed presentation page. As will be appreciated, in other embodiments these gestures may be assigned other functions. For example, the gesture illustrated in FIG. 9C may alternatively be assigned the function of causing the system 20 to enter the presentation mode 82.

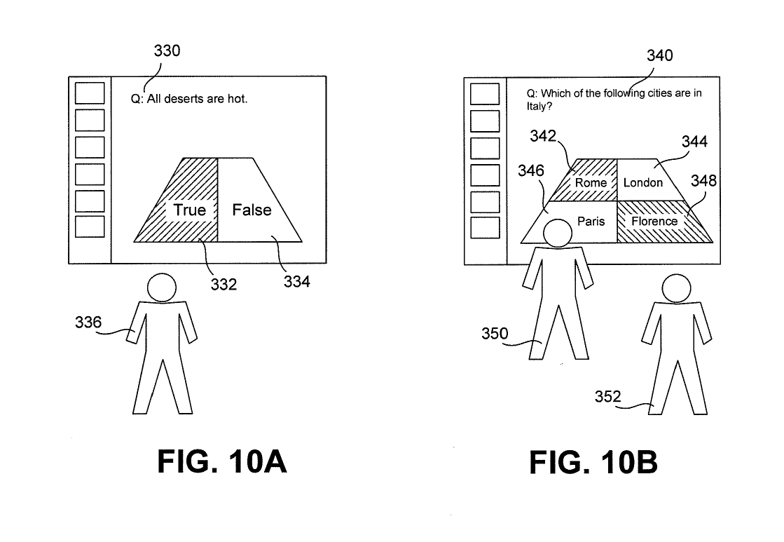

As will be appreciated, interactive input system 20 may run various software applications that utilize output from proximity sensors 50, 52, 54 and 56 as input for the applications. For example, FIG. 10A shows an application in which a true/false question 330 is displayed on interactive surface 24. Possible responses are also displayed on interactive surface 24 as graphic objects 332 and 334. Here, the area generally in front of interactive board 22 and within the detection ranges of proximity sensors 50, 52, 54 and 56 is divided into a plurality of regions (not shown) associated with the graphic objects 332 and 334. A user 336 may enter a response to the question 330 by standing within one of the regions. In the embodiment shown, the user 336 has selected the response associated with graphic object 332, which causes the object 332 to be highlighted. This selection is confirmed by the system 20 once the user 336 remains at this location for a predefined time period. Depending on the specific application being run, the system may then determine whether the response entered by the user is correct or incorrect. In this manner, the system thereby determines a processing result based on the output of the proximity sensors.

FIG. 10B shows another application for use with system 20, in which a multiple choice question 340 is presented to users 350 and 352. Four responses in the form of graphic objects 342, 344, 346 and 348 are displayed on the interactive surface 24. In this embodiment, the area generally in front of interactive board 22 and within the detection ranges of proximity sensors 50, 52, 54 and 56 is divided into four regions (not shown), with each region associated with one of the graphic objects 342, 344, 346 and 348. In this embodiment, the regions are arranged similarly to the arrangement of graphic objects 342, 344, 346 and 348, and are therefore arranged as a function of distance from the interactive surface 24. The system is configured to determine from the proximity sensor data the respective locations of one or more users as a function of distance from the interactive board 24, whereby each location represents a two-dimensional co-ordinate within the area generally in front of interactive board 22. In this embodiment, a response to the question needs to be entered by both users. Here, users 350 and 352 each enter their response by standing within one of the regions for longer than a threshold time period, such as for example 3 seconds. Depending on the specific application being run, the system may combine the responses entered by the users to form a single response to the question, and then determine whether the combined response is correct or incorrect. In this manner, the system determines a processing result based on the output of the proximity sensors.

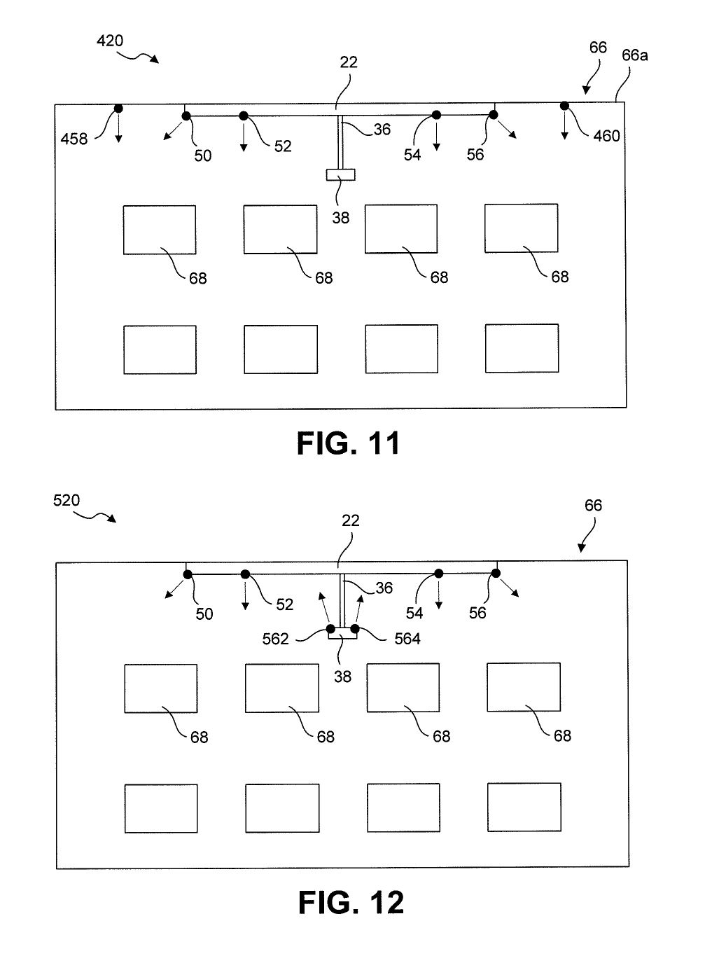

As will be understood, the number and configuration of the proximity sensors is not limited to those of the embodiments described above. For example, FIG. 11 shows another embodiment of an interactive input system installed in an operating environment 66, which is generally indicated using reference numeral 420. Interactive input system 420 is generally similar to system 20 described above with reference to FIGS. 1 to 10, however system 420 comprises additional proximity sensors 458 and 460 that are installed on the wall 66a near the interactive board 22. Proximity sensors 458 and 460 may communicate with the processing structure via either wired or wireless communication. As compared to system 20 described above, proximity sensors 458 and 460 generally provide an extended range of detection, and thereby allow system 420 to better determine the locations of objects located at the periphery of the interactive board 22. Still other configurations are possible. For example, FIG. 12 shows another embodiment of an interactive input system installed in an operating environment 66, which is generally indicated using reference numeral 520. Interactive input system 520 is generally similar to system 20 described above with reference to FIGS. 1 to 10, however system 520 comprises additional proximity sensors 562 and 564 mounted on projector boom 532 and near projector 38. In this embodiment, proximity sensors 562 and 564 face downwardly towards the interactive board 22. As compared to system 20 described above, proximity sensors 562 and 564 generally provide an extended range of detection and in an upward direction with respect to proximity sensors 50, 52, 54 and 56.

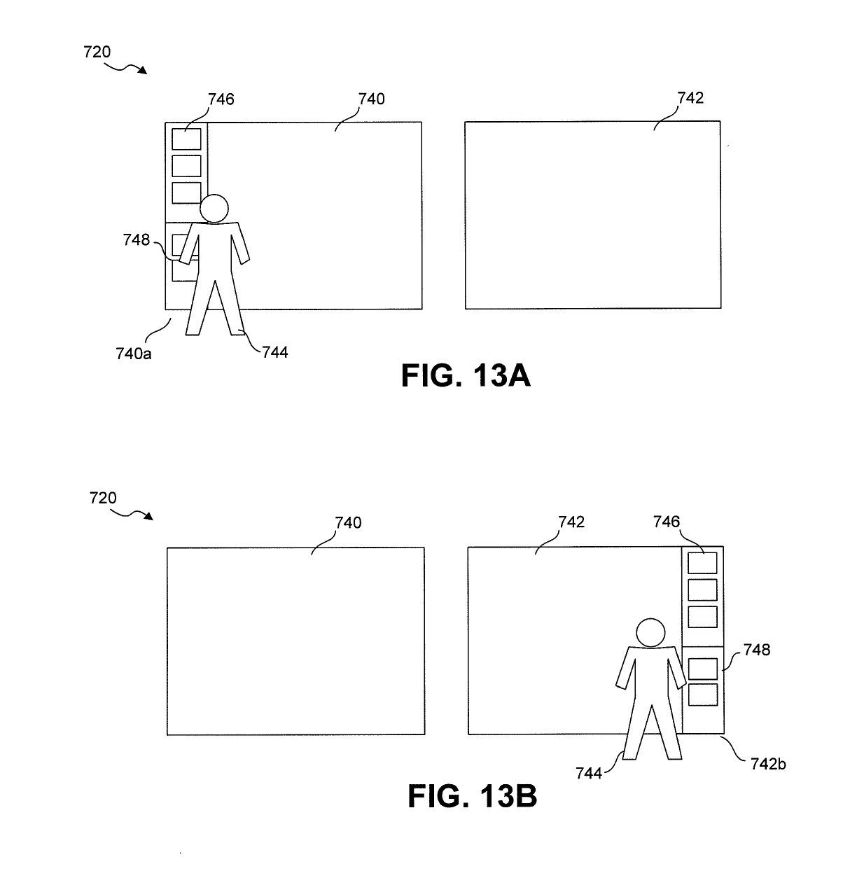

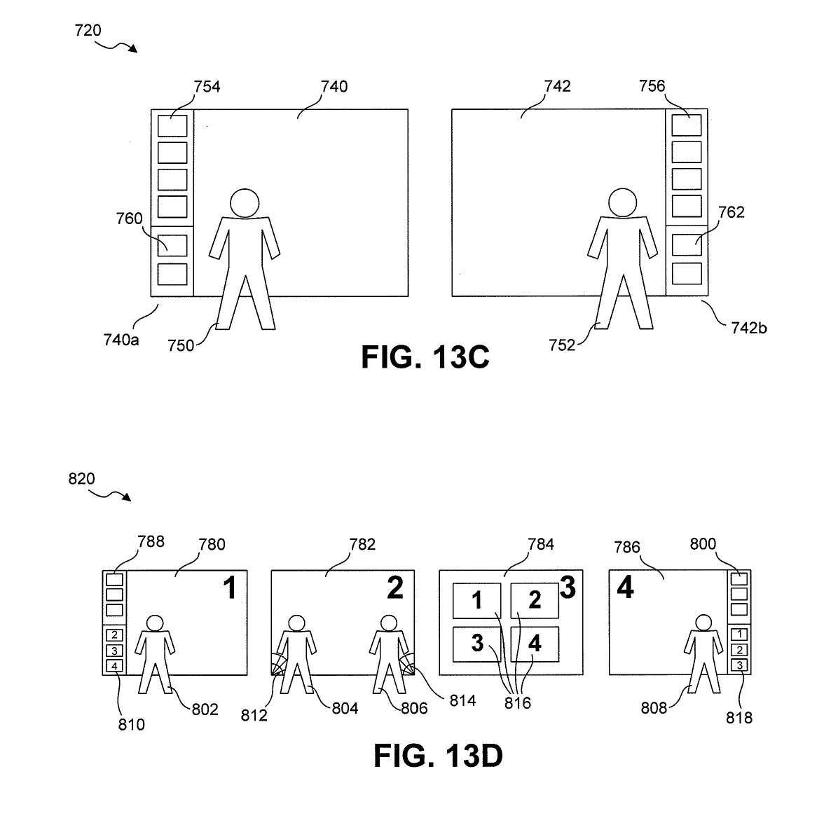

FIGS. 13A to 13D show another embodiment of an interactive input system, which is generally indicated using reference numeral 720. Interactive input system 720 is generally similar to interactive input system 20 described above with reference to FIGS. 1 to 10, however instead of having a single interactive board, interactive input system 720 comprises two interactive boards 740 and 742. Similar to the interactive board 22 described above, each of the interactive boards 740 and 742 comprise four proximity sensors (not shown) arranged in similar manner as proximity sensors 50, 52, 54 and 56, as shown in FIG. 1. In FIG. 13A, the system 720 has detected a single user 744 located near a first end 740a of interactive board 740. Accordingly, UI components in the form of page thumbnail images 746 and 748 are displayed along the left edge of the interactive surface of interactive board 740. In the embodiment shown, page thumbnail images 746 are images of slides of a presentation, and page thumbnail images 748 are images of the slides recently displayed on interactive surfaces 740 and 742. Page thumbnail images 746 and 748 may be selected by the user 744 so as to display full size pages on interactive surfaces 740 and 742. Similar to the embodiments described above, page thumbnail images 746 and 748 are positioned so as to allow the user 744 to easily select one of the thumbnail images 746 and 748 by touch input, and without requiring the user 744 to move from location. In FIG. 13B, the system 720 has detected that the user 744 has moved towards a second end 742b of interactive board 742. Consequently, the page thumbnails 746 and 748 are displayed by the system 720 along the right edge of the interactive surface of interactive board 742.

In FIG. 13C, the system 720 has detected two users, namely first and second users 750 and 752 located near the first and second ends 740a and 742b of interactive boards 740 and 742, respectively. System 720 has entered a multi-user sub-mode, and accordingly has assigned each of the interactive boards 740 and 742 to a respective user. On interactive board 740, display content comprising UI components in the form of image thumbnails 754 of presentation slides, together with image thumbnails 760 of display content recently displayed on interactive board 740, is displayed. Similarly, on interactive board 742, display content comprising UI components in the form of image thumbnails 756 of presentation slides, together with thumbnail images 762 of the display content recently displayed on interactive board 742, is displayed.

Still other configurations of multiple interactive screens are possible. For example, FIG. 13D shows another embodiment of an interactive input system, which is generally indicated using reference numeral 820. Interactive input system 820 is generally similar to interactive input system 720, however instead of having two interactive boards, interactive input system 820 comprises four interactive boards 780, 782, 784 and 786. Each of the interactive boards 780, 782, 784 and 786 comprises four proximity sensors (not shown) arranged in similar manner as proximity sensors 50, 52, 54 and 56 shown in FIG. 1. Here, the system 820 has detected a single user 802 located in front of interactive board 780, and accordingly has assigned the entire interactive surface of interactive board 780 to user 802. UI components in the form of image thumbnails 788 of display, together with thumbnail images 810 of the current display content of interactive boards 782, 784 and 786, are all displayed on interactive board 780 at a position near user 802. System 820 has detected two users, namely first and second users 804 and 806 located near the ends of interactive board 782. System 820 has assigned one of two zones (not shown) within interactive board 782 to a respective user 804 and 806. Unlike the embodiment shown in FIG. 8C, no separation line is shown between the two zones. UI components in the form of image thumbnails 812 and 814 of display content, and of the current display content of interactive boards 780, 784 and 786, are displayed in each of the two zones. The system 820 has not detected a user near interactive surface 784, and accordingly has entered a presentation mode with regard to interactive surface 784. Here, thumbnail images 816 of display content of all of the interactive boards 780, 782, 784 and 786, are displayed. System 820 has detected a single user 808 located in front of interactive surface 786, and accordingly has assigned interactive surface 786 to user 808. UI components in the form of image thumbnails 800 of display content, together with thumbnail images 818 of the current display content of interactive boards 780, 782 and 784, are all displayed on interactive board 786.

Although in the embodiments described above, the system comprises imaging assemblies positioned at corners of the interactive board, in other embodiments the system may alternatively comprise one or more imaging assemblies installed adjacent the projector and facing generally towards the interactive surface. Such a configuration of imaging assemblies has been disclosed previously in U.S. Patent Application Publication No. 2008/0106706 to Holmgren, et al., the entire content of which is fully incorporated herein by reference.

Although in embodiments described above the proximity sensors are in communication with a master controller housed within a tool tray, in other embodiments, other configurations may alternatively be used. For example, the master controller may alternatively not be housed within a tool tray. In other embodiments, the proximity sensors may alternatively be in communication with a separate controller that is not a master controller, or may alternatively be in communication directly with the computing device.

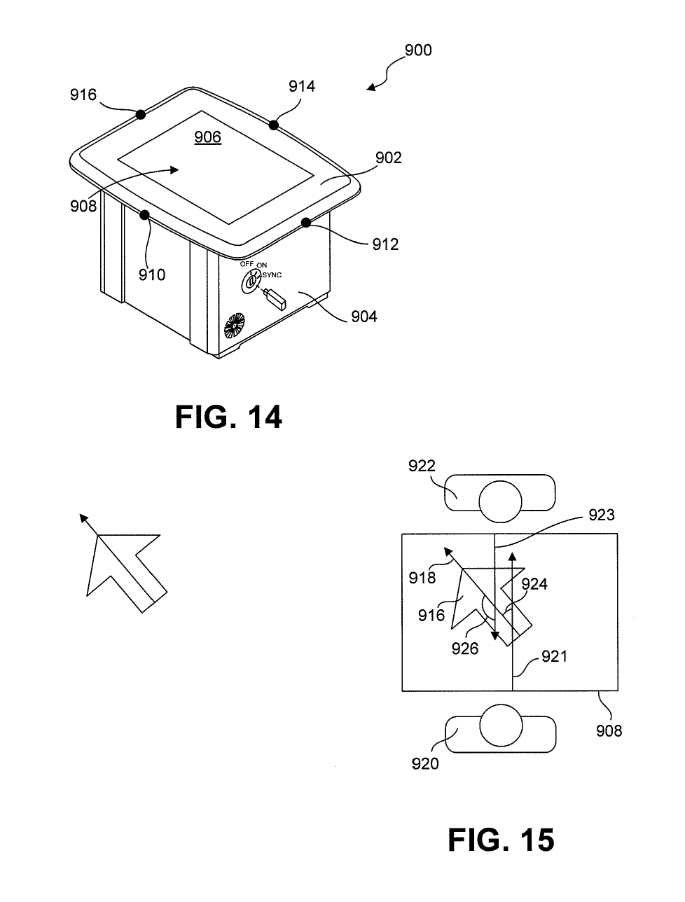

FIG. 14 shows another embodiment of an interactive input system, and which is generally indicated using reference numeral 900. Interactive input system 900 is in the form of an interactive touch table. Similar interactive touch tables have been described, for example, in U.S. patent application Ser. No. 12/240,953 to Sirotich, et al., entitled “TOUCH PANEL FOR AN INTERACTIVE INPUT SYSTEM, AND INTERACTIVE INPUT SYSTEM INCORPORATING THE TOUCH PANEL”, filed on Sep. 28, 2008, the entire content of which is fully incorporated herein by reference. Interactive input system 900 comprises a table top 902 mounted atop a cabinet 904. In this embodiment, cabinet 904 sits atop wheels, castors or the like that enable the interactive input system 900 to be easily moved from place to place as desired. Integrated into table top 902 is a coordinate input device in the form of a frustrated total internal reflection (FTIR) based touch panel 906 that enables detection and tracking of one or more pointers, such as fingers, pens, hands, cylinders, or other objects, applied thereto.

Cabinet 904 supports the table top 902 and touch panel 906, and houses processing structure (not shown) executing a host application and one or more application programs. Image data generated by the processing structure is displayed on the touch panel 906 allowing a user to interact with the displayed image via pointer contacts on the display surface 908 of the touch panel 906. The processing structure interprets pointer contacts as input to the running application program and updates the image data accordingly so that the image displayed on the display surface 908 reflects the pointer activity. In this manner, the touch panel 906 and processing structure allow pointer interactions with the touch panel 906 to be recorded as handwriting or drawing or used to control execution of the application program.

Processing structure in this embodiment is a general purpose computing device in the form of a computer. The computer comprises for example, a processing unit, system memory (volatile and/or non-volatile memory), other non-removable or removable memory (a hard disk drive, RAM, ROM, EEPROM, CD-ROM, DVD, flash memory etc.) and a system bus coupling the various computer components to the processing unit.

Interactive input system 900 comprises proximity sensors positioned generally on its sides. In this embodiment, proximity sensors 910, 912, 914 and 916 are positioned on the four edges of table top 902, as illustrated. As will be understood, the proximity sensors 910 to 916, together with the supporting circuitry, hardware, and software, as relevant to the purposes of proximity detection, are generally similar to that of the interactive input system 20 described above with reference to FIGS. 1 to 10. Similarly, interactive input system 900 utilizes interactive, presentation and sleep modes 80, 82, and 84, respectively, as described above for system 20. The touch table uses the proximity information to assign workspaces, adjust contextual UI components and receive gestures in a way similar to what have been described above. The touch table also uses the proximity information to properly orient images displayed on the table surface, and to answer questions.

FIG. 15 shows an example of display content comprising an image 916 displayed on the display surface 908 of interactive input system 900. Image 916 has an upright direction 918 associated with it that is recognized by the system 900. In the embodiment shown, interactive input system 900 has detected two users 920 and 922. Based on the known spatial configuration of proximity sensors 910, 912, 914 and 916, system 900 has assigned each of users 920 and 922 respective viewing directions 921 and 923 generally facing table surface 908, as illustrated. In this embodiment, system 900 orients the image 916 to an orientation such that image 916 is easily viewable to users 920 and 922. Here, the system 900 calculates an angle between the viewing direction and the upright direction 918 of the image 916 for each of the detected users. In the embodiment illustrated, system 900 calculates an angle 924 between viewing direction 921 and upright direction 918, and an angle 926 between viewing direction 923 and upright direction 918. Having calculated these angles, system 900 then determines a orientation for image 916 having a new upright direction 918a (not shown), for which the largest of all such angles calculated based on new upright direction 918a is generally reduced, if possible, and with the constraint that new upright direction 918a is parallel with a border of display surface 908. For the embodiment shown, angles 924a and 926a calculated based on new upright direction 918a would be equal or about equal. The image is then displayed (not shown) on display surface 908 in the orientation having the new upright direction 918a.

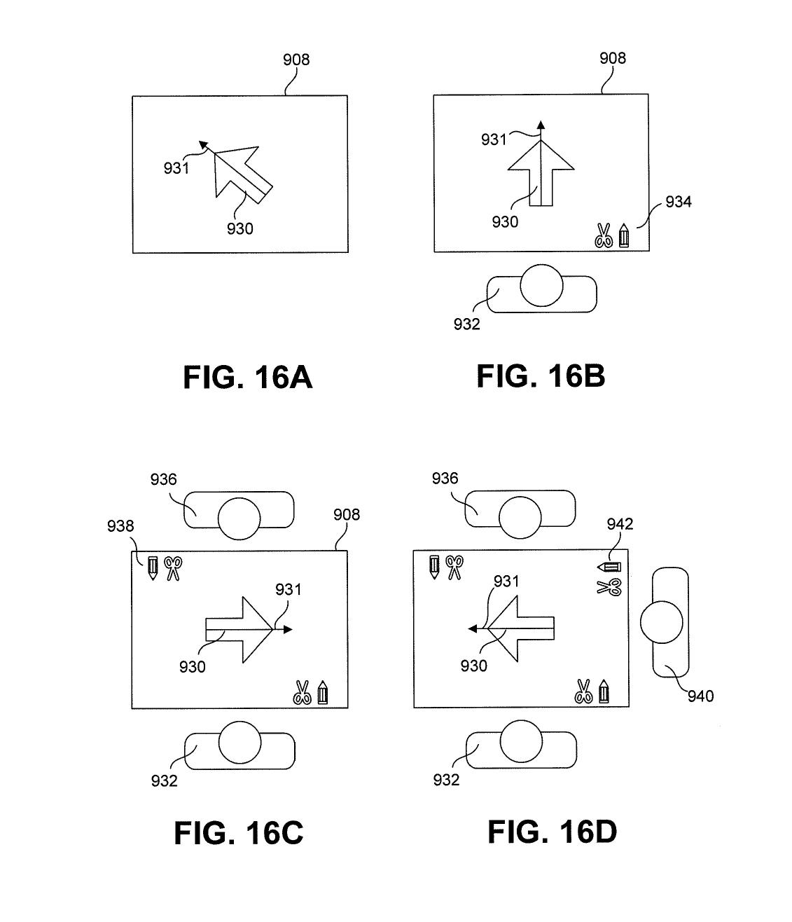

FIGS. 16A to 16D show several examples of display content for use with interactive input system 900. FIG. 16A shows an image 930 having an upright direction 931 displayed on display surface 908. In the embodiment shown, interactive input system 900 has not detected presence of any users, and accordingly is in presentation mode. In FIG. 16B, system 900 has detected the appearance of a user 932, and has therefore entered the interactive mode. System 900 has reoriented image 930 so that it appears as upright to user 932. A set of UI components in the form of tools 934 has been added, and is displayed at a corner of display surface 908 near user 932.

In this embodiment, having detected the presence of only a single user 932, the system 900 limits the maximum number of simultaneous touches that are to be processed by the system of 10. Here, the system only processes the first 10 simultaneous touches and disregards any other touches that occur while the calculated touches are still detected on touch surface 908 and until the detected touches are released. In some further embodiments, when more than 10 touches are detected, the system determines that touch input detection errors have occurred, such as by, for example, multiple contacts per finger or ambient light interference, and automatically recalibrates the system to reduce the touch input detection error. In some further embodiments, the system displays a warning message to prompt users to properly use the system, for example, to warn users to not bump fingers against the interactive surface.

In this embodiment, “simultaneous touches” refers to when the system samples output of the image sensor to detect touches, more than one touch is detected. As will be understood, these touches may not necessarily occur at the same time and, owing to the relatively high sampling rate of the image sensor, there may be a scenario in which a new touch occurs before the existing touches are released (i.e., before the fingers are lifted). For example, at a time instant t₁, there may be only one touch detected. At a subsequent time instant t₂, the already-detected touch is still detected while a new touch is detected. At a further subsequent time instant t₃, the already-detected two touches are detected while a further new touch is detected. In this embodiment, the system will continue detecting touches until 10 touches are reached.

In FIG. 16C, the system has detected the appearance of a second user 936. System 900 has reoriented 930 to an orientation that is suitable for both users 932 and 936. A set of UI components in the form of tools 938 has been added, and is displayed at a corner of display surface 908 near user 936. In this embodiment, the system 900 limits the maximum number of simultaneous touches to 20.

In FIG. 16D, the system 900 has detected a third user 940, and has reoriented image 930 to an orientation that is suitable for all users 932, 936 and 940. A set of tools 942 are provided to user 940 at an adjacent corner. A set of UI components in the form of tools 942 has been added, and is displayed at a corner of display surface 908 near user 940. In this embodiment, the system 900 limits the maximum number of simultaneous touches to 30.

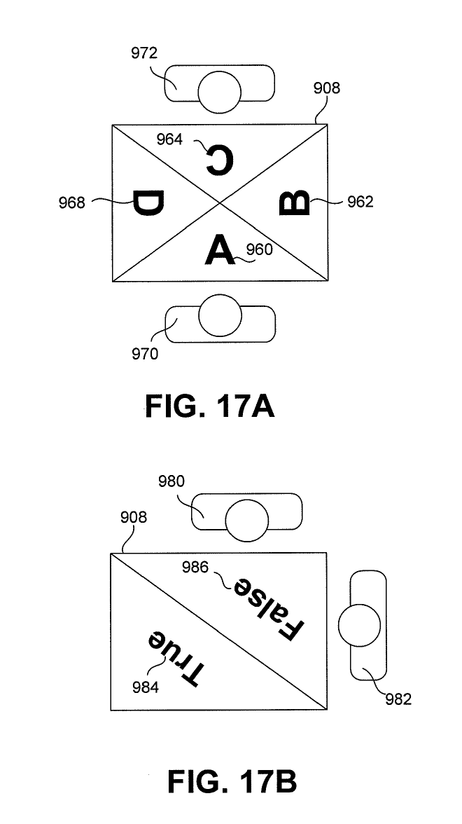

Similar to interactive input system 20 described above, interactive input system 900 may run various software applications that utilize output from proximity sensors 910, 912, 914 and 916 as input for the applications. For example, FIG. 17A shows an application being run on system 900 in which a multiple choice question (not illustrated) is presented to users 970 and 972. Four responses in the form of graphic objects 960, 962, 964 and 968 to the multiple choice question are displayed on the display surface 908. Any of users 970 and 972 may enter a response by standing near one of the graphic objects 960, 962, 964 and 968 and within detection range of the corresponding proximity sensor 910, 912, 914 and 916 for a longer than a predefined time period.

FIG. 17B shows another application being run on system 900 in which a true/false question (not shown) is presented to users 980 and 982. Two responses in the form of graphic objects 984 and 986 are displayed on the display surface 908. In this embodiment, the question needs to be answered collaboratively by both users. Users 980 and 982 together enter a single response by both standing near the graphic object corresponding to their response for longer than a predefined time period. As illustrated, system 900 also has reoriented graphic objects 984 and 986 to a common orientation that is suitable for both users 980 and 982.

Although in embodiments described above the system determines an orientation for an image having a new upright direction with a constraint that the new upright direction is parallel with a border of display surface, in other embodiments, the new upright direction may alternatively be determined without such a constraint.

Although in embodiments described above the system comprises an interactive board on which two proximity sensors are mounted and a tool tray on which two proximity sensors are mounted, the system is not limited to either this number or this arrangement of proximity sensors, and in other embodiments, the system may alternatively comprise any number or arrangement of proximity sensor or proximity sensors.

Although in embodiments described above the system has a sleep mode in which the system is generally turned off, with the exception of “wake-up” circuits, in other embodiments, the system may alternatively display content such as advertising or a screen saver during the sleep mode.

Although in embodiments described above the system enters the interactive mode after the system starts, in other embodiments, the system may alternatively enter either the presentation mode or the sleep mode automatically after the system starts.

Although in embodiments described above the system has a sleep mode in which the output from only some proximity sensors are monitored while other proximity sensors are shut down, in other embodiments, all of the proximity sensors may alternatively still be operating and their outputs be monitored during the sleep mode.

Although embodiments have been described with reference to the drawings, those of skill in the art will appreciate that variations and modifications may be made without departing from the spirit and scope thereof as defined by the appended claims.

What is claimed is:

1. An interactive input system comprising:
an interactive surface;
at least one proximity sensor positioned in proximity with the interactive surface; and
processing structure communicating with the sensor and processing sensor output from the at least one proximity sensor for detecting a user in proximity with the interactive surface.

2. The interactive input system of claim 1, wherein the processing structure is configured to update display content for display on the display surface based on the sensor output.

3. The interactive input system of claim 2, wherein the processing structure is configured to update the display content for display on the display surface near a location of the user.

4. The interactive input system of claim 2, wherein the processing structure is configured to update the display content according to a viewing direction of the user.

5. The interactive input system of claim 1, wherein the system is configured to operate in any of an interactive mode, a presentation mode, and a sleep mode.

6. The interactive input system of claim 5, wherein the interactive mode comprises a single user sub-mode and a multiple user sub-mode.

7. The interactive input system of claim 5, wherein the system enters at least one of the sleep mode and the presentation mode in absence of user detection for a period of time exceeding a threshold period of time.

8. The interactive input system of claim 6, wherein the system enters the interactive mode from the sleep mode or the presentation mode upon detection of a user for a period of time exceeding a threshold period of time.

9. The interactive input system of claim 1, wherein the processing structure is further configured for detecting a gesture based on the sensor output.

10. The interactive input system of claim 1, wherein the processing structure is further configured for detecting at least one of presence of the user within a detection range of the sensor and distance of the user from the sensor.

11. The interactive input system of claim 1, wherein the processing structure is further configured for processing the sensor output for determining a processing result.

12. The interactive input system of claim 1, wherein the processing structure is further configured to limit the number of simultaneous touches to be processed by the system based on the sensor output.

13. The interactive input system of claim 1, wherein the processing result is a response to a question displayed on the display surface.

14. A method of providing input into an interactive input system having an interactive surface, the method comprising:
communicating sensor output from at least one proximity sensor positioned in proximity with the interactive surface to processing structure of the interactive input system; and
processing the sensor output for detecting a user located in proximity with the interactive surface.

15. The method of claim 14, further comprising updating display content displayed on the interactive surface based on the output.

16. The method of claim 14, further comprising entering any of an interactive mode, a presentation mode, and a sleep mode, based on the sensor output.

17. The method of claim 16, wherein the interactive mode comprises a single user sub-mode and a multiple user sub-mode.

18. The method of claim 14, further comprising processing the sensor output for detecting a gesture.

19. The method of claim 14, further comprising determining a processing result from the sensor output.

20. The method of claim 19, wherein the processing result is a response to a question displayed on the display surface.

21. The method of claim 14, further comprising limiting the number of simultaneous touches to be processed by the system based on the sensor output.
